(19) United States
(12) Patent Application Publication
(10) Pub. No.: US 2012/0232933 A1
(43) Pub. Date: Sep. 13, 2012

(54) CORPORATE WELLNESS CERTIFICATION METHOD

(76) Inventor: Joe Russ, Centerton, AR (US)

(21) Appl. No.: 13/045,801

(22) Filed: Mar. 11, 2011

(51) Int. Cl. G06Q 40/00

(52) U.S. Cl. 705/4

(57) ABSTRACT

A renewable preventative health care wellness certification that may be recognized as sufficient proof that an insured individual member of a health insurance policy has enrolled, studied, and proficiently become educated on course content regarding health and wellness to satisfy a standard exam score. The certification may be recognized by the insurance carrier and may qualify the insured individual for a reduction in the individual's health insurance premium rate.

### BACKGROUND OF THE INVENTION

### Cross Reference

Not Applicable.

### Field of the Invention

This invention relates generally to a corporate wellness certification method, and more particularly, but not by way of limitation, to a method of ensuring that an insured individual is educated on health issues.

### Description of the Related Art

The cost of health care is a major concern to individuals, employers, and insurers alike. One of the best ways to control health care expenditures is through proper preventative measures, including education. An individual who is well educated on how to maintain his or her health and overall physical function is more likely to take steps to stay healthy, thus lowering the cost of future health care to the individual, as well as the cost to the individual's employer and/or insurer.

Based on the foregoing, it is desirable to provide an incentive to individuals to become educated on wellness issues. It is further desirable to incentivize such education through a reduction in the individual's health insurance rate.

The Health Insurance Portability and Accountability Act has nondiscrimination provisions that generally prohibit insurers from charging different rates for similarly situated individuals. There is an exception to this general rule permitting insurers to rewards for a wellness program so long as the reward is not based on the individual satisfying a standard related to a health factor. There are five requirements for a permissible wellness program: (1) the reward must not exceed twenty percent (20%) of the cost of the individual's coverage; (2) the program must be reasonably designed to promote health and prevent disease; (3) the program must allow an individual to quality for the reward at least once per year; (4) the reward must be available to all similarly situated individuals; and (5) the insurer must disclose the availability of a reasonable alternative standard.

Based on the foregoing, it is further desirable to provide the incentive discussed above in a way that complies with the nondiscrimination provisions of HIPAA.

### SUMMARY OF THE INVENTION

In general, in a first aspect, the invention relates to a method comprising: providing information to an insured individual, where the insured individual has an insurance policy with a premium rate; administering a test to the insured individual, where the test covers the information; providing a certification to the insured individual if the insured individual passes the test; and reducing the premium rate of the insured individual if the insured individual receives the certification.

The information may concern how to improve one's health and overall physical function. The information may be provided in the form of a course of study, which may be provided in a classroom-type setting, over the internet or other media, or through self-study. The information may include appropriate measures one must take to help prevent illness and health problems. The information may also include basic preventative exercises.

The test may be standardized, and may be administered on a computer, on a mobile device, over the internet, or in persona The test may include a written component, a practical component, or both. The insured individual may pass the test if the insured individual meets a pre-determined test score criteria representing proficiency in the information. The certification may be valid for one year. If the insurance policy is periodically renewed, the certification may be valid until the insurance policy is renewed.

The steps of providing information, administering the test, and providing certification may be provided by a third party, and not by an insurer or an employer of the insured individual.

### BRIEF DESCRIPTION OF THE DRAWINGS

FIG. 1 is a flow chart illustrating the corporate wellness certification method.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In general, in a first aspect, the invention relates to a renewable preventative health care wellness certification that may be recognized as sufficient proof that an insured individual member of a health insurance policy has enrolled, studied, and proficiently become educated on the course content to satisfy a standard exam score. The course, exam, and certification may be accomplished via the internet, video, seminar, and/or practical instruction. The certification may be recognized by the insurance carrier and may qualify the insured individual for a reduction in the individual's health insurance premium rate.

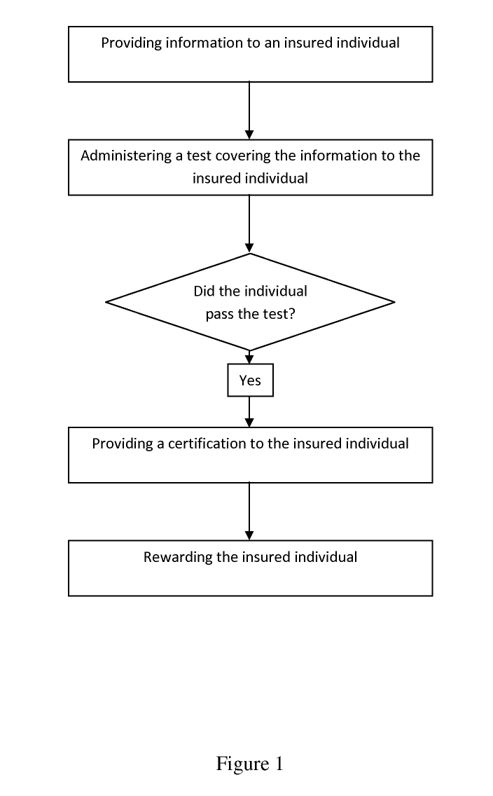

As seen in FIG. 1, the method begins with providing information to an insured individual. The information may concern how to improve one's health and overall physical function. The information may be provided in the form of a course of study. The course may be provided in a classroom-type setting, over the internet or other media, or through self-study. The course content may include published information regarding the appropriate measures one must take to help prevent illness and health problems. It may also include instruction on basic preventative exercises requiring no special equipment or location to complete. The exercises may address each body part and may be reasonably possible to perform on a daily basis, such as during the workday.

The next step is to administer a test covering the information to the insured individual. The test may be standardized. The test may be administered on a computer, on a mobile device, over the internet, or in person, and may include a written component, a practical component, or both. The test administrator may determine a test score criteria representing proficiency in the information.

The next step is to award the insured individual a certificate of completion if the insured individual meets the test score criteria. The certification may be valid for a particular time period, such as one year. The term of the certification may coincide with the term of the insured individual's health insurance policy contract. The certification may not be based on a health related factor, and does not profile or discriminate.

The insured individual's health care insurer may then recognize the value of the insured individual's knowledge obtained from the course as proven by the earned certification and share the foreseen savings in expenditure with the insured in the form of a reduction in the insured individual's insurance policy premium.

The provision of information, testing, and certification may be offered by a third-party rather than the insured individual's insurer or employer. Thus, the certification may remain in the insured individual's possession regardless of whether the insured individual changes insurers or employers. The goal is for the certification to be broadly recognized and transferable. The third party may be paid by the insured individual, by the insured individual's employer, or by the insured individual's insurer.

The expected result of the corporate wellness certification method is that it will empower the average individual with a basic proficiency regarding how to maintain one's health and overall physical function. This may help decrease the frequency of physician visits and the related costs associated with ancillary health care services for the individual who obtains and comprehends the necessary knowledge the course offers. This in turn may decrease the expenditures of the individual's health insurance carrier.

The certification method may require very little to no cost on the part of the employer or insurer. The certification may be obtained and paid for by the insured individual. The corporate wellness certification method may be ideal for large self-insured employers in that there may be no corporate funds invested in implementing the program. The insurer may have a great proportional benefit of decreasing expenditures resulting from a healthier base enrollment while retaining the flexibility to adjust premium rates to cover any later potential loss arising from honoring and promoting the certification. The insured individual may benefit from the potential of decreased out-of-pocket expenditures on health care by being educated on more skillfully and strategically using the health care system, implementing the learned health behavior, and any real or perceived savings extended to them by the insurer. The insurer and/or employer may also gain a public relations advantage by offering the benefits of the certification as an option to the insured as a method of providing some financial relief from inevitable health insurance premium increases. Additionally, this process may complement existing wellness programs implemented by the insurer.

Whereas, the devices and methods have been described in relation to the drawings and claims, it should be understood that other and further modifications, apart from those shown or suggested herein, may be made within the spirit and scope of this invention.

1. A method comprising:
providing information to an insured individual, where the insured individual has an insurance policy with a premium rate and where the information pertains to appropriate measures one may take to help prevent illness;
administering a test to the insured individual via a computer or a mobile device, where the test covers the information;
providing a certification to the insured individual if the insured individual passes the test; and
rewarding the insured individual if the insured individual receives the certification by reducing the premium rate of the insured individual, decreasing co-pay amounts of the insured individual, lowering deductibles of the insured individual, or qualifying the insured individual for insurance.

2. The method of claim 1 where the information concerns how to improve one's health and overall physical function.

3. The method of claim 1 where the information is provided in the form of a course of study.

4. The method of claim 3 where the course of study is provided in a classroom-type setting, over the internet, or through self-study.

5. The method of claim 1 where the information includes appropriate measures one must take to help prevent illness and health problems.

6. The method of claim 1 where the information includes basic preventative exercises.

7. The method of claim 1 where the test is standardized.

8. (canceled)

9. The method of claim 1 where the test includes a written component, a practical component, or both.

10. The method of claim 1 where the insured individual passes the test if the insured individual meets a pre-determined test score criteria representing proficiency in the information.

11. The method of claim 1 where the certification is valid for one year.

12. The method of claim 1 where the insurance policy is periodically renewed, and where the certification is valid until the insurance policy is renewed.

13. The method of claim 1 where the steps of providing information, administering the test, and providing certification are not performed by an insurer or an employer of the insured individual.

14. (canceled)
